(19) United States
(12) Patent Application Publication
(10) Pub. No.: US 2023/0401336 A1
(43) Pub. Date: Dec. 14, 2023

(54) Enhanced Synthetic Data and a Unified Framework for Quantifying Privacy Risk in Synthetic Data

(71) Applicant: Anonos IP LLC, Beaverton, OR (US)

(72) Inventors: Malcolm Gary LaFever, Lyons, CO (US); Ted N. Myerson, New York, NY (US); Mark Little, Matthews, NC (US); Candy Pearson, Monticello, WI (US); Marc Bachan, Glenside, PA (US); Matteo Giomi, Berlin (DE); Christoph Sebastian Wehmeyer, Berlin (DE)

(21) Appl. No.: 18/334,167

(22) Filed: Jun. 13, 2023

Related U.S. Application Data
(60) Provisional application No. 63/366,296, filed on Jun. 13, 2022.
(60) Provisional application No. 63/379,828, filed on Oct. 17, 2022.

(51) Int. Cl. G06F 21/62

(52) U.S. Cl. CPC G06F 21/6254

(57) ABSTRACT

Embodiments disclosed herein improve data privacy and security by combining synthetic data and statutory pseudonymization to create protected data that is more effectively disconnected from the original source data. By bringing synthetic data and statutory pseudonymization techniques together, a flexible level of protection may be applied to data that strikes an appropriate balance between the ease of use of cleartext data and the aggressive protection of statutory pseudonymization. Further embodiments disclosed herein improve data privacy and security by providing a novel statistical framework that jointly quantifies different types of privacy risks in synthetic datasets and that includes attack-based evaluations for the singling out, linkability, and inference risks. According to other embodiments, the modular nature of the framework facilitates the future integration of new and potentially stronger attacks for evaluating privacy risks. The framework separates the evaluation of the success rate of the privacy attacks from the calculation of the reported privacy risks.

### CROSS-REFERENCE TO RELATED APPLICATIONS

This application claims the benefit under 35 U.S.C. § 119(e) of U.S. Provisional Patent Application No. 63/366,296, filed Jun. 13, 2022, entitled, “Synthetic Data 2.0 Enhanced with Statutory Pseudonymisation” (hereinafter, “the '296 application”) and U.S. Provisional Patent Application No. 63/379,828, filed Oct. 17, 2022, entitled, “Anonymeter Framework for Quantifying Privacy Risk in Synthetic Data” (hereinafter, “the '828 application”), the disclosures of which are each incorporated herein by reference in their entireties.

### FIELD OF THE INVENTION

This disclosure relates generally to improving data security, privacy, and analysis, and, in particular, to using technological improvements to enhance the privacy of synthetic data and enable a statistical framework that jointly quantifies different types of privacy risks in synthetic datasets.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Synthetic data is often presented as a method for sharing sensitive information in a privacy-preserving manner by reproducing the global statistical properties of the original data without disclosing sensitive information about any individual. In practice, as with other anonymization methods, synthetic data may not entirely eliminate privacy risks. These residual privacy risks need instead to be ex-post uncovered and assessed. However, quantifying the actual privacy risks of any given synthetic dataset is a hard task, given the multitude of facets of data privacy.

Disclosed herein is a novel statistical framework to jointly quantify different types of privacy risks in synthetic datasets, also referred to herein as “Anonymeter” or the “Anonymeter framework.” This framework includes attack-based evaluations for singling out, linkability, and inference risks, which are the three key indicators of anonymization risk according to data protection regulations, such as the European General Data Protection Regulation (GDPR). Anonymeter represents the first unified framework to introduce a coherent and legally-aligned evaluation of these three privacy risks for synthetic data, as well as to design privacy attacks that directly model the singling out and linkability risks.

Experimental results that measure the privacy risks of data with deliberately-inserted privacy leakages, and of synthetic data generated with and without differential privacy, highlight that the three privacy risks reported by the Anonymeter framework scale linearly with the amount of privacy leakage in the data. Furthermore, it has been shown that synthetic data exhibits the lowest vulnerability against linkability, indicating that synthetic data does not preserve one-to-one relationships between real and synthetic data records.

### SUMMARY

Embodiments disclosed herein may improve data privacy and security by combining synthetic data and statutory pseudonymization to create protected data that is more effectively disconnected from the original source data—i.e., with little to no risk of identity disclosure. By bringing synthetic data and statutory pseudonymization techniques together, a flexible level of protection may be applied to data that strikes an appropriate balance between the ease of use of cleartext data and the aggressive protection of statutory pseudonymization.

Further embodiments disclosed herein may improve data privacy and security by providing a novel statistical framework that jointly quantifies different types of privacy risks in synthetic datasets and that includes attack-based evaluations for singling out, linkability, and inference risks, in order to provide a coherent assessment of legally-meaningful privacy metrics. The framework also allows for the analysis of general privacy leakage as a function of the attacker's power and helps identify concrete privacy violations in synthetic datasets.

According to other embodiments disclosed herein, the modular nature of the framework facilitates the future integration of new and potentially stronger attacks for evaluating privacy risks.

According to still other embodiments disclosed herein, the framework preferably separates the evaluation of the success rate of the privacy attacks from the calculation of the reported privacy risks.

The systems, frameworks, and, if desired, other modules disclosed herein, may be implemented in program code executed by a processor, or in another computer. The program code may be stored on a computer readable medium, accessible by the processor. The computer readable medium may be volatile or non-volatile, and may be removable or non-removable. The computer readable medium may be, but is not limited to, RAM, ROM, solid state memory technology, Erasable Programmable ROM (“EPROM”), Electrically Erasable Programmable ROM (“EEPROM”), CD-ROM, DVD, magnetic cassettes, magnetic tape, magnetic disk storage or other magnetic or optical storage devices. In certain embodiments, privacy clients may reside in or be implemented using “smart” devices (e.g., wearable, movable or immovable electronic devices, generally connected to other devices or networks via different protocols such as Bluetooth, NFC, Wi-Fi, 3G, Long Term Evolution (LTE), New Radio (NR), etc., that can operate to some extent interactively and autonomously), smartphones, tablets, notebooks and desktop computers, and privacy clients may communicate with one or more servers that process and respond to requests for information from clients, such as requests regarding data attributes, attribute combinations and/or data attribute-to-Data Subject associations (wherein a Data Subject refers to any individual person who can be identified, directly or indirectly, via an identifier, or combinations of identifiers, related to a name, an ID number, location data, or via factors specific to the person's physical, physiological, genetic, mental, economic, cultural or social identity, location, behavior or attribute).

Other embodiments of the disclosure are described herein. The features, utilities and advantages of various embodiments of this disclosure will be apparent from the following more particular description of embodiments as illustrated in the accompanying drawings.

### BRIEF DESCRIPTION OF THE DRAWINGS

FIG. 1 illustrates a line graph, which shows the relationship during data synthesis between preservation of statistical relationships and the level of identity disclosure risk, in accordance with one or more embodiments disclosed herein.

FIG. 2 illustrates a block diagram, which shows three options for creating protected data outputs when both data synthesis and statutory pseudonymization are available as data protection options, in accordance with one or more embodiments disclosed herein.

FIG. 3 illustrates a schematic overview of the Anonymeter framework, in accordance with one or more embodiments disclosed herein.

FIG. 4A illustrates a flowchart, showing a method of combining synthetic data and statutory pseudonymization to create protected data, in accordance with one or more embodiments disclosed herein.

FIG. 4B illustrates a flowchart, showing a method of using a statistical framework to measures privacy risks in anonymized datasets, in accordance with one or more embodiments disclosed herein.

FIG. 5 illustrates a block diagram of an example of a programmable device for implementing techniques for utilizing synthetic data, in accordance with one or more embodiments disclosed herein.

FIG. 6 illustrates a block diagram illustrating a network of clients and a server for implementing techniques for utilizing synthetic data, in accordance with one or more embodiments disclosed herein.

### DETAILED DESCRIPTION

Societies in the digital era are faced with the challenge of striking a balance between the benefits that can be obtained by freely sharing and analyzing personal data, and the dangers that this practice poses to the privacy of the individuals whose data is concerned. Replacing original and potentially sensitive data by some “synthetic data,” i.e., data that is artificially generated—rather than coming directly from real individuals, is one of the approaches that attempt to resolve this tension. Synthetic data captures population-wide patterns of the underlying potentially sensitive data while “hiding” the characteristics of the individuals. Popular approaches for synthetic data generation rely on deep generative models such as Generative Adversarial Networks (GAN) and Variational Autoencoders (VAE). These generative models are trained on the original and potentially sensitive data to produce a synthetic dataset that preserves much of the utility of the original data.

Intuitively, if the generative models are able to generalize well, the synthetic data should not reflect the particular properties of any individual original record. This intuition underpins the use of synthetic data as a privacy enhancing technology. Unfortunately, assuming that synthetic data simply carry no privacy risks—despite being tempting—is too simplistic. Generative models with enough capacity to express complex data patterns are often found to match the original data too closely. As a consequence, the synthetic data will likely present some residual privacy risk. Reliably quantifying the privacy risk of synthetic data is therefore an important, yet still not settled, problem—even though such an assessment is not just desirable, but often represents a requirement imposed by legal frameworks, such as the GDPR, the Canadian Personal Information Protection and Electronic Documents Act (PIPEDA), the California's Consumer Privacy Act (CCPA), and others.

Differential Privacy (DP) provides a theoretical framework for upperbounding privacy leakage. However, a gap exists between the worst case privacy guarantee of DP and what can be empirically measured for practical attacks. Moreover, due to the stochastic training and inference of generative models, the magnitude of the effective privacy risks exposed by the generated synthetic data cannot be quantified in advance. Instead, the residual privacy risks need to be measured a posteriori in an empirical fashion from the generated data. However, since there exist various notions of practical privacy (e.g., membership privacy, attribute privacy, etc.), there is no unified metric for such a measurement. Instead, different metrics have been proposed to measure privacy risks for anonymized data. Yet, interpreting and combining these metrics in a meaningful way is still a research area where further improvements are needed.

Synthetic Data Enhanced with Statutory Pseudonymization

Access to data for innovation is critical for virtually all enterprises today. One of the biggest barriers to innovation is lack of predictable verifiable trust that the data can be processed (versus stored or transmitted) without significant risk of breach or misuse. Synthetic data has been identified as one potential means of enabling data use with reduced risk of breach or misuse. However, at present, it is not possible to synthesize data that is both fully accurate (i.e., relative to processing cleartext), and prevents unauthorized identity disclosure.

For this reason, the privacy benefits of synthetic data—by itself—are often overstated. While there is little doubt that synthetic data reduces risk relative to processing cleartext containing sensitive data, recent research makes it clear that there are real identity disclosure risks associated with synthetic data. Like nearly all privacy enhancing techniques (PETs) used in efforts to create anonymous data, there is a fundamental tradeoff between data protection and utility, with improvements in one usually coming at the expense of the other. In the case of synthetic data, achieving adequate accuracy can easily lead to “overfitting” and the generation of records that disclose identifying information in the source data used for data synthesis.

In addition, synthetic data must be recalibrated each time data, users, or use cases are changed to reflect new data interrelationships, increasing elapsed processing time. The challenge is that identity disclosure represents a material risk when using synthetic data. This is particularly true in use cases where high accuracy relative to processing cleartext is a requirement due to the resulting increased likelihood of overfitting resulting in models that generate records containing rare or unusual combinations of field values. Addressing this fundamental problem, when even possible, requires significant statistical expertise in techniques used for data synthesis. Additionally, in use cases that are interactive in nature, particularly those with the need to add additional data sources or incremental data, regeneration of the models and resynthesis of entire datasets is often required. Finally, referential integrity across data sets is both technically challenging and can exacerbate the risk of identity disclosure due to overfitting.

While synthetic data can be useful in certain situations, there are challenges and limitations to be aware of. The use of synthetic data does not completely sidestep data privacy regulations and requirements. Like other approaches, the techniques used to produce synthetic data still need real data as input to the generation process. This data must be treated with data protection controls to comply with relevant data protection laws such as the GDPR. The European Data Protection Supervisor (EDPS) notes the following negative foreseen impacts on data protection from synthetic data:

1) Risk of reidentification: Synthetic data generation implies a compromise between privacy and utility. The more a synthetic dataset mimics the real data, the more utility it will have for analysis but, at the same time, the more it may reveal about real people, with risks to privacy and other human rights.

2) Lack of clarity on other risks: It is unclear at this time if the data transference of generative models, which would allow other parties to generate synthetic data on their own, might bring further risks to privacy.

3) Risk of membership inference attacks: Synthetic data shares the same caveats of other forms of anonymisation regarding the risk of membership inference attacks (i.e., the possibility for an attacker to infer whether the data sample is in the target classifier training dataset), especially when it comes to outlier records (i.e., data with characteristics that stand out among other records).

As noted above, a significant limitation on the use of synthetic data is the subsequent combination of synthetic data sets, or the need to introduce new, updated, or additional data. If one has two or more tables of data that need to be protected using synthetic data creation, all of the tables need to be ready and joined first before the data can be generated. This is because the statistical relationships between variables within and between tables need to be replicated. If there is a need to update or supplement data in the source tables, or a need to add new tables, the synthetic data creation process needs to be repeated from the beginning. This is particularly a problem when conducting iterative machine learning (ML) and/or artificial intelligence (AI)-based development, as new data is constantly added to the data set in these types of processes. For analytics, different kinds of analyses may need to be performed on different sets of data, which can require the re-creation of synthetic data sets multiple times.

When dealing with complex source data containing significant noise, synthetic data can, in some cases, suffer from model overfitting, capturing the noise in the original data rather than detecting the important characteristics that predict future patterns. Overfitting can also lead to a failure to protect privacy, with rare or unusual values in the data set showing up in the synthetic data.

Statutory pseudonymization (as defined in Article 4(5) of the GDPR) requires the combination of a number of privacy preserving technical and organisational controls to restrict the ability to relink protected output to only authorised parties under controlled conditions.

Under the GDPR, the requirements of Article 4(5) fundamentally redefine pseudonymization to: (a) dramatically expand the scope to include all personal data, vastly more comprehensive than direct identifiers; and (b) dramatically restrict the scope of additional information that is lawfully able to re-attribute personal data to individuals. The first part of the Article 4(5) definition, by itself, means: (a) the outcome must be for a dataset and not just a technique applied to individual fields because of the expansive definition of “personal data” under the GDPR (i.e., all information that relates to an identified or identifiable individual) as compared to just direct identifiers; (b) additional information could come from anywhere, except the dataset itself; and (c) replacement of direct identifiers with static tokens could suffice.

However, when combined with the second part of the Article 4(5) definition of pseudonymization, the requirements regarding additional information mean that any combination of additional information sufficient to re-attribute data to individuals must be under the control of the data controller or an authorized party. To achieve this level of protection, it is necessary to: (a) protect all indirect identifiers and attributes as well as direct identifiers; and (b) use dynamism by assigning different pseudonyms at different times for different purposes to avoid unauthorized re-linking via the so-called “Mosaic Effect,” i.e., the effect that occurs when a person is indirectly identifiable via linkage attacks because some datasets can be combined with other datasets known to relate to the same individual, thereby enabling the individual to be distinguished from others.

“Statutory pseudonymization,” as disclosed herein, offers significant benefits relative to synthetic data. Chief among them are the improved protection against unauthorized identity disclosure, full accuracy relative to processing cleartext, and, when authorized, the ability to relink to original cleartext source data values. Statutory pseudonymization may be used to mitigate the identity disclosure risks in the face of high accuracy requirements when using Synthetic data. According to some embodiments, a process of using statutory pseudonymization may comprise the following steps:

Step 1: Start with a cleartext dataset to create a synthetic dataset, however, in contrast to other synthetic data approaches, where close attention must be paid to overfitting in order to avoid identity disclosure risks, using statutory pseudonymization enables the data to be set up to maximize the accuracy and preservation of the statistical interrelationships contained in the generated synthetic data without regard to the identity disclosure risks that might otherwise exist in the resulting data.

Step 2: Take the newly created data set, which is a synthetic data source, and treat it as if it was an actual identifying data source and apply statutory pseudonymization to it. Because the data is synthetic, only a limited number of records need to be focused on, thereby enabling a less aggressive approach to be applied to pseudonymization, since only the small percentage of records that present risk will need to be protected, i.e., most of the records will not present any risk at all. For example, only light protections may need to be applied, e.g., pseudonymizing field names or performing generalization of a limited number of fields. The resulting protected data set would not look like encrypted data but would be “Statutorily Pseudonymized” data, the status of which is not dependent on what the data looks like, but rather on the fact that it is not possible to re-attribute identity without access to the additional information held separately.

Step 3: Once the pseudonymized version of the synthetic data set is created, it could be suitable for use in certain use cases, or could be used for the purposes of training a very accurate machine learning model. And, once that model is learned, it may be restored to cleartext or kept in pseudonymized form, and then actual production data may be used to create an equivalent pseudonymized dataset to run in production.

Step 4: This enables data engineers to do feature engineering and iteration in something that is nearly all cleartext, making it easy to work, while still having the privacy benefits of statutory pseudonymization for when the system switches over to processing live data using the model.

As may now be appreciated, one benefit of using pseudonymized data is that it can produce a dataset that has superior control over the risk of re-identification. Pseudonymized data is also better in terms of protection than synthetic data by itself, for any given level of accuracy. That is, given a fixed level of accuracy with pseudonymized data, 100% accuracy and better protection may be achieved than with other alternative forms of data protection. This is achievable because: (i) the pseudonymizing is being performed on categorical variables, so that, mathematically, there is no loss in precision relative to the original cleartext (but there is increased privacy); and (ii) the privacy protection is controllably reversible, when authorized (i.e., there is no loss of utility from pseudonymizing data that otherwise could not be protected with anonymous data).

One advantage of synthetic data is that, to a large extent, it removes any direct linkages between records in the synthetic data set and the original data set. There may be some residual identity disclosure risk to the extent that there are elements of the source dataset that are unusual or rare outliers. It is not possible to preserve the full set of statistical relationships without replicating unusual or rare outlier values in a resulting synthetic data set. The other advantage of synthetic data is that it is in cleartext, such that users can see what data they are working with, thereby providing a more intuitive and natural environment for processes like feature engineering and developing machine learning models, which are highly iterative processes.

By combining synthetic data and statutory pseudonymization, however, protected data may be created that is completely disconnected from the original source data—i.e., with little or no risk of identity disclosure. Synthetic data provides the ease of use associated with instantaneous recognition by users, as opposed to having its values hidden behind pseudonyms and having to deal with that level of lack of transparency. But, it also provides the ability to replace unique outlier values with tokens, while requiring reversal to reattribute the tokens to identity. By bringing them together, depending on the specific ways the data is to be used (e.g., for exploratory data analysis, feature engineering, machine learning, etc.), a flexible level of protection may be applied to the data by trading off between the ease of use of cleartext and the aggressive protection of pseudonymization to find the optimal combination of the two—without having to compromise on the level of protection. As may now be more fully appreciated, at least some degree of pseudonymization is needed to remove any residual identification or identity disclosure that might be in the synthetic data.

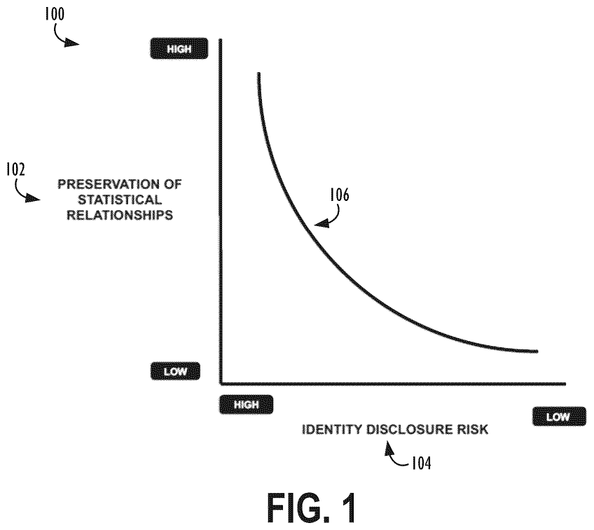

Turning now to FIG. 1, a line graph 100 is shown, which includes a line 106, illustrating the relationship during data synthesis between preservation of statistical relationships (i.e., “accuracy”) on the vertical axis (102) and the level of identity disclosure risk on the horizontal axis (104). As illustrated by exemplary line 106, generally-speaking, as the accuracy of the synthesized data improves (i.e., higher on axis 102), the level of identity disclosure risk increases (i.e., higher on axis 104), and vice versa.

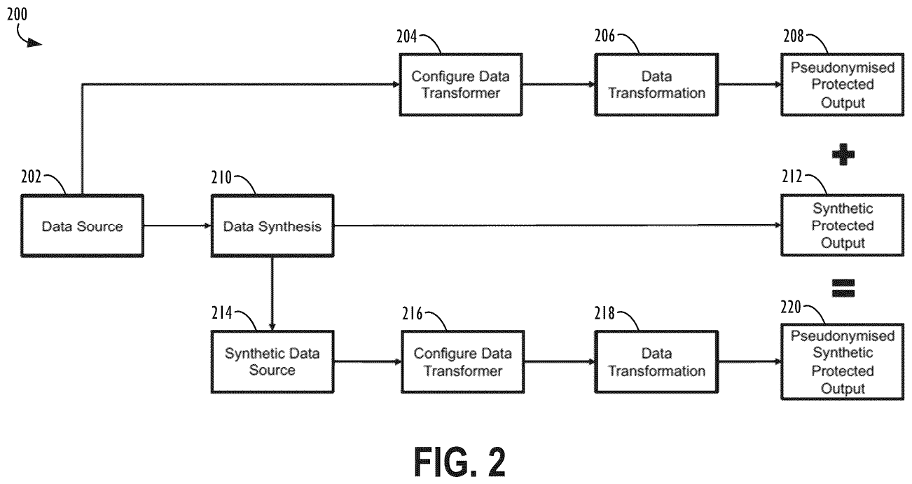

Turning now to FIG. 2, a block diagram 200 is illustrated, which shows three options for creating protected data outputs when both data synthesis and statutory pseudonymization are available as data protection options. The top flow path shows the steps that may be followed from a data source (202), through configuring a data transformer (204) and data transformation (206), to arrive at a statutorily pseudonymized protected data output (208). The middle path shows the steps that may be followed from the data source (202), through data synthesis (210) directly to a synthetic protected data output (212). The bottom path shows the steps from the data source (202) to data synthesis (210), resulting in a synthetic data source (214), and following through to configuring a data transformer (216), and transforming the data (218), to arrive at a data output (220) that is protected using both statutory pseudonymization and synthetic data techniques.

Anonymeter Framework

As mentioned above, the Anonymeter framework disclosed herein provides an empirical statistical framework that measures privacy risks in anonymized datasets. According to some embodiments, the Anonymeter framework implements a general three-step procedure for risk assessment based on: (1) performing privacy attacks against the dataset under evaluation, (2) measuring the success of such attacks, and (3) quantifying the exposed privacy risk in a well-calibrated and coherent manner. Each of the three steps may be connected to the others via common interfaces to keep the framework modular and to allow the same risk quantification method to be shared by different privacy risks.

For each privacy attack, the final risk is obtained by comparing the results of the privacy attack against two baselines: the first baseline resulting from performing the same attack on a control dataset from the same distribution as the dataset under evaluation; and the second baseline resulting from performing a random attack against the dataset under evaluation. While the latter provides insights into the strength of the main attack, the former makes it possible to measure how much of the attacker's success is simply due to the utility of the synthetic data—and how much is instead an indication of actual privacy violations. Within this framework, three attacks are proposed to aid in the quantification of the risks of singling out, linkability, and inference (i.e., the three privacy metrics defined by the Article 29 Data Protection Working Party).

An experimental validation of the Anonymeter framework may be performed by testing its ability to detect different amounts of privacy leaks. Experimental results of the Anonymeter framework, e.g., as detailed in the '828 application that has been incorporated by reference, have demonstrated that the Anonymeter framework is able to detect these leaks, that the reported risks scale linearly with the amount of privacy leaks present in the dataset, and that risk-computation is efficient even on large datasets. The '828 application also shows that the Anonymeter framework outperforms existing evaluation frameworks for synthetic data in both computational performance and quality of privacy-assessment. Furthermore, the experimental results confirm that synthetic data exhibits the highest risks to inference and singling out attacks, whereas the risk to linkability is comparably low over all datasets which have been evaluated. This provides empirical evidence for the common intuition that generating synthetic data breaks the one-to-one links between data records. As expected, introducing DP into the training of the generative models also causes a general decrease in the privacy risks reported by the Anonymeter framework. As may now be understood, a higher utility of the generated data corresponds to a higher reported risk, i.e., the more the synthetic data is close to the original data, the higher the risk reported by the Anonymeter framework.

Disclosed herein are various implementations of: singling out, linkability, and inference privacy attacks. Yet, the modularity of the Anonymeter framework allows for a simple and consistent integration of additional attack-based privacy metrics. Anonymeter is designed to be widely usable and to provide interpretable results, requiring minimal manual configuration and no expert knowledge beyond basic data analysis skills. It is also applicable to a wide range of datasets and to both numerical and categorical data types. Anonymeter is sensitive and able to identify and report even small amounts of privacy leaks. Although developed for the specific use case of synthetic data, Anonymeter does not make any assumption on how the data is created, except for requiring consistency of attributes and data types, and it can also be applied to assess other forms of anonymization and pseudonymization.

The following notation is used herein: a tabular dataset X is a collection of N records x=(x₁, . . . , x_{d}), each with d attributes, drawn from a distribution D. Subscripts ori and syn are used to denote original datasets, i.e., collections of data records sampled from D, and synthetically created datasets, respectively. More in detail, an original dataset is denoted by Xₒᵣᵢ={xlₒᵣᵢ, . . . , xNₒᵣᵢ}, and a synthetic dataset is denoted by X_{syn}={xl_{syn}, . . . , xM_{syn}}.

Matrix notation is used to indicate columns in the datasets: X[:, i] is a vector of size N containing the i^{th} attribute of each record, and x[i]=xᵢ is the value of the i^{th} attribute of record x. Finally, G denotes the generative model from which the synthetic dataset X_{syn} is produced.

Synthetic Data Generation

In general, synthetic data is produced by a generative model G that is supposed to learn the distribution D. However, since this distribution is usually unknown, the model G is instead trained on Xₒᵣᵢ sampled from D. Once trained, the model G(Xₒᵣᵢ) can be understood as a stochastic function that, without any input, generates synthetic data records X_{syn}. By querying G multiple times, a full synthetic dataset X_{syn} can be sampled. Ideally, the generated synthetic data should reflect most of the statistical properties of the distribution D. Yet, since G only has access to Xₒᵣᵢ and only learns a partial representation of the data distribution, the generated data can only approximate D.

Several methods exist to generate synthetic data. One possibility is to use statistical models, such as Bayesian networks or Hidden Markov models. Such models generate explicit parametric representations of D and the features to be extracted from Xₒᵣᵢ are determined beforehand. In contrast, deep learning models for synthetic data generation, such as GANs and VAEs, learn which attributes to extract during a stochastic training process.

Privacy Preserving Synthetic Data

As described above, one of the main reasons to generate synthetic data is for the purpose of privacy-preserving data releases and data sharing, i.e., synthetic datasets are supposed to reproduce properties of an original dataset Xₒᵣᵢ from D without containing the personal data from Xₒᵣᵢ. Yet, recent studies indicate that, through high-utility synthetic data, it is still possible for an attacker to extract sensitive information about the original data.

The Conditional Tabular Generative Adversarial Network (CTGAN) is one framework that may be used to generate the synthetic data for experimentation. CTGAN is a GAN that uses a conditional generator to enable the generation of synthetic tabular data with both discrete and continuous-valued columns. The approach uses a mode-specific normalization as an improvement for non-Gaussian and multimodal data distributions. Privacy guarantees can be integrated into CTGAN using DP. In some cases, the generative model is trained with a DP optimizer. As a result of the post-processing robustness of DP, the synthetic data generated from such DP models also enjoy the same level of privacy guarantee as the trained generative model.

Privacy Metrics and Attacks in Synthetic Data

Privacy is a multi-faceted concept, which is reflected in the availability of dozens of different privacy metrics. In the concrete case of measuring the privacy leakage of synthetic data, many studies rely on similarity tests, distance metrics calculating the mean absolute error between original and generated data records, or on measuring the number of identical records between original and synthetic datasets. When the synthetic data is generated with DP guarantees, the DP privacy budget, usually denoted by £, can also be used to report on the privacy of a synthetic dataset. However, for most of these metrics, it is unclear how they translate into privacy implications in practice and what the concrete privacy risks exist for individual data records. Therefore, using the success rate of concrete privacy attacks is becoming a common approach to quantifying the privacy of synthetic data.

According to embodiments disclosed herein, the evaluation of the three privacy attacks that anonymization techniques must protect from according to the GDPR privacy regulation are integrated into the Anonymeter framework, i.e.: singling out, linkability, and inference. Prior evaluation frameworks typically have only jointly considered a subset of these legally-essential risks. The importance to consider these three risks against anonymization results from their implication on individuals' privacy. For example, singling out can be seen as a way to indirectly identify a person in a dataset. At the same time, it can serve as a stepping stone towards linkage attacks, which have been shown to yield complete de-anonymization of datasets. Inference attacks, in turn, can disclose highly sensitive information on individuals, such as their genomics.

Singling out happens whenever it is possible to deduce that, within the original dataset, there is a single data record with a unique combination of one or more given attributes. For example, an attacker might conclude that, in a given dataset Xₒᵣᵢ, there is exactly one individual with the attributes of: gender: male, age: 65, ZIP-code: 30305, number of heart attacks: 4. It is important to note that singling out does not imply re-identification, yet the ability to isolate an individual is often enough to exert control on that individual, or to mount other privacy attacks.

Linkability is the possibility of linking together two or more records (either in the same dataset or in different ones) belonging to the same individual or group of individuals. This can be used for de-anonymization. Due to statistical similarities between the generated data and the original data, linkability risks may still exist in synthetic datasets.

Inference happens when an attacker can confidently guess (or infer) the value of an unknown attribute of the original data record. An example of successful inference would consist in the attacker being able to confidently deduce that a record in the original dataset Xₒᵣᵢ, with attributes “gender”: male, “age”: 65, “ZIP-code”: 30305 holds the secret attribute “number of heart attacks”: 4. When measuring privacy risks, an important distinction has to be made between what an attacker can learn at a population-level (generic information) and on an individual-level (specific information). Generic information is what provides utility to the anonymized data; specific information enables the attacker to breach the privacy of some individuals. The Anonymeter framework distinguishes between what the attacker learns from the anonymized dataset as generic information from specific inference, thus quantifying the privacy risk. Thus, the Anonymeter framework provides a coherent assessment of diverse privacy risks based on different privacy attacks.

To provide a conservative privacy risk assessment, the Anonymeter framework considers the strongest threat model in which the attacker is in full possession of the synthetic dataset. Moreover, the attacker holds additional partial but correct knowledge, called “auxiliary information,” about a subset of the original records (i.e., the target records). This accounts for practical scenarios where overlapping data sources are common. Depending on the amount and quality of the auxiliary information, more or less powerful attacks can be modeled. Simple heuristics may then be used to choose the auxiliary knowledge for the respective attacks. The targeted original records may be chosen at random from the original dataset Xₒᵣᵢ. That is, no assumption is made on how the attacker would choose the targets, resulting in a more robust evaluation of the overall privacy offered by the synthetic data. If needed, however, the Anonymeter framework can easily be adapted to attack specific records, for example, to measure privacy risks for some specific sub-population in the data, or particular individuals.

For the purposes of these experiments, the data generation mechanism may be treated as a black-box that cannot be accessed or queried by the attacker, who only receives the synthetic dataset. Concerning the original dataset Xₒᵣᵢ, it is assumed to consist of N records drawn independently from the population D, where each record refers to a different individual. The full original dataset is split into two disjoint sets Xₜᵣₐᵢₙ and X_{control}. That is, Xₒᵣᵢ=Xₜᵣₐᵢₙ∪X_{control} and Xₜᵣₐᵢₙ∩X_{control}=Π. The synthetic dataset X_{syn} is sampled from a generative model trained on Xₜᵣₐᵢₙ exclusively: X_{syn}˜G(Xtrain). To fully evaluate privacy, Anonymeter utilizes all three datasets, i.e., Xₜᵣₐᵢₙ, X_{syn}, and X_{control}. All the datasets have the same number of attributes, d, but the number of records might differ.

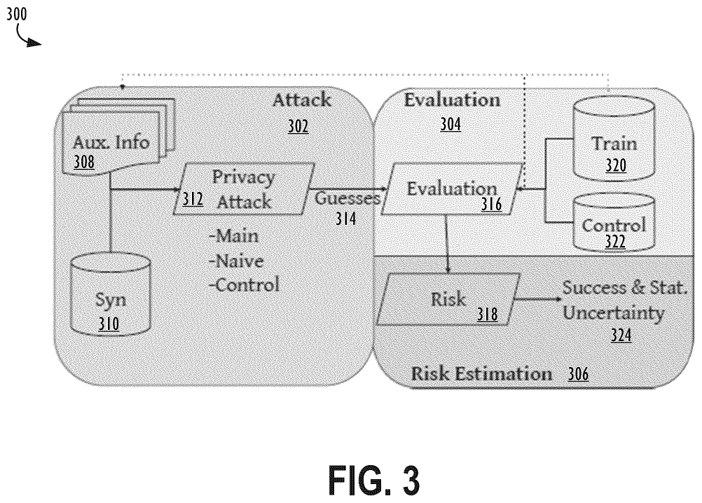

Turning now to FIG. 3, a schematic overview of the Anonymeter framework 300 is shown. The attacker is given access to the full generated synthetic dataset (310) and some auxiliary information (308). In the attack phase (302), the framework 300 performs three different privacy attacks (312), i.e., main, naive, and control, each of which outputs guesses (314) on the original private data. The correctness of these guesses (314) is then evaluated (316) in the evaluation phase (304) against the original training data (320) for the main and naive attacks, and/or against the control data (322) for the control attack. Based on the evaluation, in a risk estimation phase (306), a final statistical risk quantification (318) is output to provide a quantification of success in the attack and statistical uncertainty (324).

Privacy risks in the Anonymeter framework may be estimated following a common procedure, as described above with reference to FIG. 3. In this modular design, the analysis is made up of three sequential steps: (1) the attack phase, in which the privacy attacks are carried out, (2) the evaluation phase, in which the success of the attacks is measured, and (3) the statistical risk estimation phase, in which the privacy leakage for the attack is quantified. How the concrete attacks and evaluation phases are carried out may differ for each evaluated privacy risk, but the way the risks are derived from the results of the evaluation phase may be common to all cases. This consistent view improves the interpretability of the different attack results and makes the Anonymeter framework more modular.

Attack Phase: The attack phase consists of executing three different attacks. First, the “main” privacy attack in which the attacker uses the synthetic dataset X_{syn} to deduce private information of records in the training set Xₜᵣₐᵢₙ. Second, a “naive” attack is carried out based on random guessing, to provide a baseline against which the strength of the “main” attack can be compared. Finally, to distinguish the concrete privacy risks of the original data records (i.e., specific information) from general risks intrinsic to the whole population (i.e., generic information), a third “control” attack is conducted on a set of control records from X_{control}. For all the risks, each of the three attacks is formulated as the task of making a set of guesses: g={g₁, . . . , g_{NA}} on N_{A} original target records. As an example, a singling out guess could state that “there is just one person in the original dataset who is male, 65 years old and lives in area 30305.” The naive attack draws its guesses at random, using the synthetic dataset only to know the domain of the dataset attributes. The main and the control attacks generate the guesses trying to actively leverage the synthetic dataset (and the auxiliary information, when available) to gain information. They both share the same attack algorithm, but, in the main privacy attack, such guesses are evaluated against Xₜᵣₐᵢₙ, whereas, in the control attack, the guesses are evaluated against X_{control}. Note that X_{control} is completely independent of the synthetic data generated from Xₜᵣₐᵢₙ. Hence, if the attacker is successful in guessing information about records in X_{control}, this must only be due to patterns and correlations that are common to the whole population Xₒᵣᵢ, rather than being specific to some training record. Therefore, the difference between the success rate of the two attacks can provide a measure of privacy leakage that occurred by training G on Xₜᵣₐᵢₙ. Thus, Anonymeter will report a privacy leakage when the attacker is more successful at targeting Xₜᵣₐᵢₙ than X_{control}.

Evaluation Phase: In the evaluation phase, the guesses from the attack phase are compared against the truth in the original data to estimate the privacy risk. The outcome of the evaluation phase is a vector of bits o={o₁, . . . , o_{NA}}, where oᵢ=1 if the ith guess gᵢ is correct, otherwise oᵢ=0. Each attack defines the criteria for a guess to be considered correct. In the singling out example from above, the guess would be considered correct if there indeed exists exactly one such individual in the original data.

Risk Quantification Phase: In the risk quantification phase, success rates of the “main” privacy attack are derived from the evaluation, together with a measure of the statistical uncertainties due to the finite number of targets. Under the assumption that the outcome oᵢ of each attack is independent from the others, o can be modeled as Bernoulli trials. The true privacy risk, \hat{r}, may be defined as the probability of success of the attacker in these trials. The best estimate r of the true attacker success rate \hat{r} and the accompanying confidence interval \hat{r}∈r±δr for confidence level a are estimated via the Wilson Score Interval:

$$r = \frac{{N}_{S} + {z}_{α}^{2} / 2}{{N}_{A} + {z}_{α}^{2}} \\ {δ}_{r} = \frac{{z}_{α}}{{N}_{A} + {z}_{α}^{2}} \sqrt{\frac{{N}_{S} ( {N}_{A} - {N}_{S} )}{{N}_{A}} + \frac{{z}_{α}^{2}}{4}} , \qquad ( Equation 1 ) ,$$

with Nₛ=Σᵢ₌₁^{N}^{_{A}}oᵢ being the total number of correct guesses, and z_{α} the probit, i.e., the inverse of the cumulative distribution function of the normal distribution, corresponding to the confidence level α. Using Equation (1) and the number of successful guesses for each of attack we evaluate the success rates for the “main”, “naive”, and “control” attacks as (rₜᵣₐᵢₙ±δᵣₐᵢₙ), (rₙₐᵢᵥₑ±δₙₐᵢᵥₑ), and (r_{control}±δ_{control}), respectively.

The success rate of the naive attack provides a baseline to measure the strength s of the attack, which can be defined as the difference between the success rate of the main attack against training records and the success rate of the naive attack, i.e.:

s=rₜᵣₐᵢₙ−rₙₐᵢᵥₑ (Equation 2),

with the error on s obtained via error propagation as δₛ=\sqrt{δᵣ²+δₙₐᵢᵥₑ²}.

If the attack is weaker than the naive baseline, i.e., rₙₐᵢᵥₑ≥r, the attack is said to have failed. This can happen in the case of incorrect modeling, for instance when the attacker is given too little auxiliary information or auxiliary information that is uncorrelated with the targets of the guesses, or when the synthetic dataset has little utility and it is actually misleading for the attack. In such cases, the Anonymeter framework may warn the user that the results are considered void of meaning and should be excluded from the analysis. Excluding invalid attacks is important in practice, because it avoids the situation in which “no risk” is reported due to the incorrect modeling of the attacks.

For the “control” attack, the attack's success rate is evaluated on control records (r_{control}) using Equation (1). Intuitively, if the synthetic dataset contains more information on the training records than on those in the control set, this implies rₜᵣₐᵢₙ≥r_{control}. From these two success rates, the specific privacy risk R is derived as:

$$R = \frac{{r}_{train} - {r}_{control}}{1 - {r}_{control}} , \qquad ( Equation 3 )$$

Where the numerator in the above expression corresponds to the excess of attacker success when targeting records from Xₜᵣₐᵢₙ versus the success when the targets comes from X_{control}. The denominator represents the maximum improvement over the control attack that a perfect attacker (r=1) can obtain, and helps contextualizing the difference at the numerator by acting as a normalization factor. For example, suppose that, out of 100 guesses, the attacks against the training and control sets are correct 90 and 80 times, respectively, i.e., rₜᵣₐᵢₙ=0.9 and r_{control}=0.8. Of the 90 correct guesses of the main privacy attack, 80 could be explained as being due the utility of the dataset, leaving the remaining 10 correct guesses to indicate privacy violations. This 0.1 excess in the success rate rₜᵣₐᵢₙ translates in a R=0.5 risk, since the best possible attack can only score 100 out of 100 guesses, i.e., its rate can only be 0.2 higher than r_{control}. Other ways of normalizing the risk have been proposed, but, according to the embodiments disclosed herein, the normalizing baseline (r_{control}), is derived from attacking a control set of records, rather than from the success of the naive attack.

If both success rates are identical, access to the synthetic data does not give the attacker any benefit to gain information about the training data, i.e., the success of the attack can be explained by the general utility of the synthetic data. In other words, it is a consequence of general inference. If, however, the success rate on training data exceeds the one on control data, this shows that information has been leaked from the synthetic data.

Properties of privacy risk: There are no unified requirements on properties that privacy metrics should possess. The privacy risks, according to the embodiments disclosed herein, may have three desired properties. First, the correctness of the guesses generated by the attacker may be evaluated. Second, the privacy metrics may report the uncertainty of the risks, e.g., through confidence intervals. Third, and finally, if the proposed privacy metric is accurate, it is able to measure the actual percentage of data leaked from the synthetic dataset. In some implementations, a privacy metric may be considered meaningful if the value of R˜0 if (and only if) the evaluated dataset is independent of the original data (i.e., non-interference), and the reported risk increases proportionally with the amount of privacy leaks. Finally, privacy risks are preferably based on probabilities, namely the probabilities of making correct guesses on the sensitive data.

Practical Privacy Evaluation Bounds

In general, an attack-based privacy analysis provides a lower bound for the privacy risk (in contrast to theoretical frameworks, such as DP that provide upper bounds, i.e., worst-case guarantees). Therefore, the computed privacy risks are just as representative as the employed attacks are. Yet, in practice, using attack-based approaches to quantify privacy leakage has become state-of-the-art in several domains, such as machine learning.

To overcome potential limitations of an attack-based approach, according to some embodiments disclosed herein, attackers are modeled as being both powerful and knowledgeable, i.e., it is assumed that the attacker holds knowledge of the entire synthetic dataset, that is, the worst case scenario, in which the synthetic data is released to the public. In many practical applications, the value of the datasets that are processed discourages such scenarios. In addition, for the linkability and inference estimation, partial but correct auxiliary knowledge of some original records is also available to the attacker. Finally, the attack strength may be evaluated by comparing to a baseline attack based on the uninformed guesses from the naive attack. This adds the context needed to interpret the results correctly. In particular, the results are only valid if the “main” attack is able to outperform the baseline scenario.

Anonymeter Framework Privacy Attacks

Concrete instantiations of three privacy attacks to assess the fundamental risks of singling out, linkability, and inference within the Anonymeter framework will now be described in greater detail. Attacks measuring these specific three risks are considered due to their importance in the relevant privacy legislation, e.g., according to the GDPR, any successful anonymization technique must provide protection against such risks. For each privacy risk, the design and implementation of both the attack and the evaluation phase are discussed. The risk quantification phase is common to all attacks.

Singling out: The singling out attack is given the task to create N_{A} many predicates based on the synthetic data that might single out individual data records in the training dataset. As stated above, it produces guesses like: “there is just one person in the original dataset who is male, years old and lives at area 30305”. The intuition behind this approach is that attributes (or combinations thereof) that are rare or unique in the synthetic data might also be rare or unique in the original data. Therefore, access to the synthetic data would allow for generating more meaningful predicates than uninformed guessing.

Attack Phase: For the attack phase, two algorithms may be utilized, namely the univariate PredicateFromAttribute algorithm and the multivariate MultivariatePredicate algorithm (shown in pseudocode, below), that can be used to generate the N_{A} many singling out predicates (i.e., guesses). While the univariate algorithm creates predicates using single attributes, the multivariate algorithm relies on the combination of several attributes.

```
  Algorithm 1: Creating a univariate singling out predicates for at-
  tribute a.
```

| | |
|---|---|
| 1 | def PredicateFromAttribute(X, a): |
| 2 | \| predicates ← [ ]; |
| 3 | \| if Sum (X_{syn}[:,a] == NaN) == 1 then |
| 4 | \| \| predicates + = ″a Is NaN″; |
| 5 | \| end |
| 6 | \| if IsContinuous (a) then |
| 7 | \| \| predicates + = ″a ≤ min(X_{syn}[:,a])″; |
| 8 | \| \| predicates + = ″a ≥ max(X_{syn}[:,a])″; |
| 9 | \| end |
| 10 | \| for v In Set (X_{syn}[:,a]) do |
| 11 | \| \| if Sum (X_{syn}[:,a] == v) == 1 then |
| 12 | \| \| \| predicates + = ″a == v″; |
| 13 | \| \| end |
| 14 | \| end |
| 15 | \| return predicates; |

Algorithm 1 (PredicateFromAttribute), shown above, samples all unique attribute values in the synthetic dataset as predicates. For categorical attributes or in the case of missing values, such unique values are values that appear only once in the dataset. For numerical continuous attributes, the maximum and minimum value of the respective attribute may be used and the predicate is created based on being smaller than the minimum or larger than the maximum value. The intuition behind this approach is to exploit outlier values in all the one-way marginals. Such univariate predicates are especially designed to exploit privacy leaks in pre- and post-processing, e.g., when numerical values sampled from the generative models are scaled to ranges derived from the original dataset, or when high-cardinality categories (such as identifiers or addresses) are preserved. By running Algorithm 1 for all attributes in a dataset, a large collection of univariate singling-out predicates may be obtained. The attacker picks N_{A} of them at random to use them as guesses.

```
  Algorithm 2: Create a multivariate predicate from the attributes of
  record x.
```

| | |
|---|---|
| 1 | def MultivariatePredicate (X, attributes, x): |
| 2 | \| predicates ← [ ]; |
| 3 | \| for a In attributes do |
| 4 | \| \| p ← ″″; |
| 5 | \| \| if (x[a] == NaN) then |
| 6 | \| \| \| p ← ″a Is NaN″; |
| 7 | \| \| end |
| 8 | \| \| if IsContinuous (a) then |
| 9 | \| \| \| if x[a] ≥ median (X[:,a]) then |
| 10 | \| \| \| \| p ← ″a ≥ x[a]″; |
| 11 | \| \| \| else |
| 12 | \| \| \| \| p ← ″a ≤ x[a]″; |
| 13 | \| \| \| end |
| 14 | \| \| else |
| 15 | \| \| \| p ← ″a == x[a]″; |
| 16 | \| \| end |
| 17 | \| \| predicates += P; |
| 18 | \| end |
| 19 | \| predicate ← LogicalAnd (predicates); |
| 20 | \| return predicate |

Algorithm 2 (MultivariatePredicate), shown above, creates predicates as the logical combinations of univariate predicates created from randomly selected synthetic data records. It starts by drawing a random record \tilde{x} from the synthetic dataset and considering a random set of attributes {a₁, . . . , a_{d}}. A multivariate predicate is then formulated as the logical AND of the univariate expressions derived from the values of \tilde{x}. If attribute aᵢ is categorical or not a number, the expression sets aᵢ to be equal to \tilde{x}[aᵢ]. If aᵢ is numerical, the expression sets for values of aᵢ either greater or equal or smaller or equal than \tilde{x}[ai]. The sign of the inequality depends on whether \tilde{x}[aᵢ] is above or below the median of X_{syn}[aᵢ], respectively. This latter condition helps creating predicates with a higher chance of singling out. The attacker evaluates each of these predicates on the synthetic dataset and adds them to the set of guesses only if they are satisfied by a single record in X_{syn}. The fraction of generated predicates by the multivariate algorithm that passes this selection depends on the dataset and the number of attributes used to generate the guesses. For the experiments detailed in the '828 application, this fraction was globally ˜24%, i.e., to obtain N_{A} number of singling-out predicates, roughly 4*N_{A} predicates must be generated. Starting from randomly-selected synthetic records and attributes ensures that the attack predicates explore the whole parameter space, while not overfitting to the synthetic dataset.

To quantify the strength of the attack, we implement a random predicate generating algorithm as a random guessing baseline measuring the probability of creating predicates that single out an individual by chance. Such predicates are created as the joined logical AND of univariate predicates of the form: a Πv, where a is a randomly chosen attribute, Π a comparison operator selected at random, and v is a value sampled uniformly from the support of X_{syn}[:, a]. The randomly generated predicates from this algorithm are not evaluated on the synthetic dataset, and reach the evaluation phase of the analysis without undergoing the selection phase.

Evaluation Phase: For the univariate and multivariate algorithms, as well as for the naive attack, the results are sets of N_{A} predicates. These singling out guesses are evaluated on the original dataset to check whether they represent singling out predicates in the original data as well.

Risk Quantification Phase: As for each of the three privacy attacks, the output of the evaluation is used for risk quantification. To derive a unique singling out risk estimate, both the univariate and multivariate attack algorithms are run, and the one with the best performance (i.e., the highest risk) is chosen to provide a more conservative privacy assessment.

In contrast to the other privacy attacks, in the case of the singling out attack, care must be taken when comparing the results of the attack against the training set rₜᵣₐᵢₙ and the control set r_{control}. The ability of the attack to single out a record is strongly dependent on the size of the dataset. If, as it is often the case in practice, the control dataset is smaller than the training set, the number of predicates that successfully single out in the control dataset is lower by construction than in the case of singling out in the training set. To be able to measure the true privacy risk with Equation (3) it is necessary to know how many predicates would have singled out in a population of size Nₜᵣₐᵢₙ, given the number of predicates that single out in a population of size N_{control} (where N_{control}≤Nₜᵣₐᵢₙ). This may be achieved by developing a model based on the Bernoulli distribution, which is then fitted to the data to derive the scaling factor needed to compare rₜᵣₐᵢₙ and r_{control}, accounting for the different sample sizes.

Linkability: The linkability attack tries to solve the following task: “Given two disjoint sets of original attributes, use the synthetic dataset to determine whether or not they belong to the same individual.” It may be assumed that there exist two (or more) external datasets A and B containing some of the attributes of a set of original data records and that these attributes are also present in the synthetic data.

Attack Phase: In the linkability attack, the target records of the attack are a collection T of N_{A} original records randomly drawn from Xₒᵣᵢ. It may be assumed that the attacker has some knowledge on the targets, i.e., the values of the attributes in datasets A and B: T[:,A] and T[:,B]. The goal of the attack is then to correctly match records of T[:,B] to each record in T[:,A], or vice versa.

To do so, for every record in T[:,A] the attacker finds the k closest synthetic records in X_{syn}[:,A]. The resulting indices are l^{A}=(lᵢ^{A}, . . . , l_{NA}^{A}), where each lᵢ^{A} is the set of indexes of the k synthetic records that are nearest neighbors of the i^{th} target in the subspace of feature set A. The same procedure is repeated on the feature set B, resulting in the indexes l^{B} of X_{syn}[:,B]. To solve the nearest neighbor problem, a simple brute force approach using the Gower coefficient may be used to measure the distance between records. Advantageously, this distance measure naturally supports inputs with both categorical and numerical attributes. For categorical attributes, this distance is 1 in the case of a match (or if the two values are both N_{A}), and 0 otherwise. (Note: Of the three possible ways in which N_{A} can be compared, i.e., “N_{A} is equal to anything,” “N_{A} is equal to nothing,” and “N_{A} is equal to N_{A},” considering only “N_{A} equals to N_{A}” give a broader distribution of distances, which helps identifying close-by records and gives more effective comparisons in the presence of suppressed or missing values.) For numerical attributes, the distance is equivalent to the L1 distance, with the values scaled so that |xi−xj|≤1∀xi, xj∈x.

The attack procedure is then repeated using the synthetic dataset to establish links between N_{A} target records drawn from the control set. This results in the two sets of indexes l_{control}^{A} and l_{control}^{B}. Finally, a naive attack is implemented to provide a measure probability of finding the correct link by chance. For this lₙₐᵢᵥₑ^{A} and lₙₐᵢᵥₑ^{B} are obtained by drawing indexes uniformly at random from the range [0, n_{syn}−1] where n_{syn} is the size of the synthetic dataset.

Evaluation Phase: For each of the N_{A} targets, it is checked whether both identified nearest neighbor sets share the same synthetic data record. If they do, the synthetic record allows an attacker to link together previously unconnected pieces of information about a target individual in the original dataset. The attacker scores a success for every correctly established link. The outcome o of this evaluation is:

$${o}_{i} ( {l}_{i}^{A} , {l}_{i}^{B} ) = \{ \begin{matrix}1 & if {l}_{i}^{A} ⋂ {l}_{i}^{B} \neq ∅ \\ 0 & otherwise .\end{matrix} . \qquad ( Equation 4 )$$

This evaluation is performed on the outputs of the three attacks: (lA, lB) for the attack on training records, (l_{control}^{A}, l_{control}^{B}) for the attack against the control set, and (lₙₐᵢᵥₑ^{A}, lₙₐᵢᵥₑ^{B}) for the naive attack. By default, the linkability attack is performed with k=1, that is, it considers only the first nearest neighbor. Extending the search to larger values of k helps relax the definition of successful linkage by tolerating a certain degree of ambiguity. This strengthens the attack and is helpful for evaluating synthetic data where no direct one-to-one link between data records might exist.

Inference: For the inference attack, it is assumed that the attacker knows the values of a set of attributes (the auxiliary information) for some target original records. The task of the attacker is to use the synthetic dataset to make correct inferences about some secret attributes of the targets.

Attack Phase: The core of the inference attack is a nearest neighbor search, e.g., for each target record, the attacker looks for the closest synthetic record on the subspace defined by the attributes in the auxiliary information. The values for the secret attribute of the closest synthetic record constitutes the guess of the attacker which can then be evaluated for correctness. The attack is then repeated against the targets from the control set. Finally, the probability of making a correct inference by chance is measured by implementing a naive inference attack where the attacker's guesses are drawn randomly from the possible values of the secret attribute.

Evaluation Phase: For evaluation, it is considered that the attacker has made a successful inference if, for a given secret attribute, the attacker's guess is correct. Comparing the guesses with the true values of the secret in the original data, the evaluation phase may count how many times the attacker has made the correct inference. If the secret si is a categorical variable, a correct inference requires recovering the exact value. For numerical secrets, the inference is correct if the guess is within a configurable tolerance δ from the true value:

$${o}_{i} ( {s}_{i} , {g}_{i} , δ ) = \{ \begin{matrix}\frac{\vert {s}_{i} - {g}_{i} \vert}{s} \leq δ & if i numerical continuous \\ 1 & if {s}_{1} = {g}_{i} and i categorical \\ 0 & if {s}_{1} \neq {g}_{i} and i categorical\end{matrix} . \qquad ( Equation 5 )$$

Note that, since the same δ is applied to the main and the control attack, the choice of the particular value of δ has little impact on the results of the inference analysis.

Combining Synthetic Data and Statutory Pseudonymization

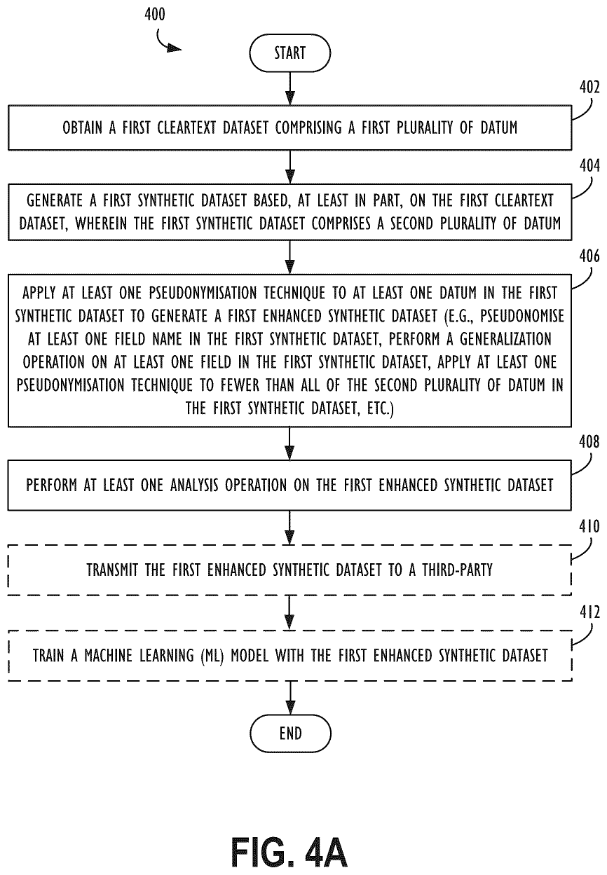

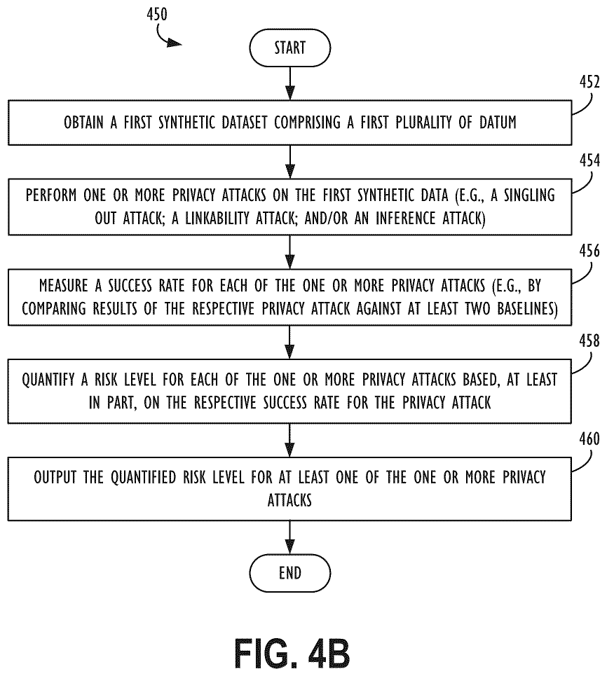

Turning now to FIG. 4A, a flowchart is shown, illustrating a method 400 of combining synthetic data and statutory pseudonymization to create protected data, according to one or more embodiments. First, at block 402, the method 400 may obtain a first cleartext dataset comprising a first plurality of datum (i.e., pieces of information or items of data, such as a fact, statistic, code, or other items of data). Next, at block 404, the method 400 may generate a first synthetic dataset based, at least in part, on the first cleartext dataset, wherein the first synthetic dataset comprises a second plurality of datum. Next, at block 406, the method 400 may apply at least one pseudonymization technique to at least one datum in the first synthetic dataset to generate a first enhanced synthetic dataset (e.g., pseudonymize at least one field name in the first synthetic dataset, perform a generalization operation on at least one field in the first synthetic dataset, apply at least one pseudonymization technique to fewer than all of the second plurality of datum in the first synthetic dataset, apply at least one pseudonymization technique to all of the second plurality of datum in the first synthetic dataset, etc.). Finally, at block 408, the method 400 may perform at least one analysis operation on the first enhanced synthetic dataset (i.e., in a privacy-respectful fashion).

At block 410, the method 400 may optionally transmit the first enhanced synthetic dataset to a third-party (e.g., so the third-party may perform analysis operation(s) on the dataset in a privacy-respectful fashion). At block 412, the method 400 may optionally train a machine learning (ML) model with the first enhanced synthetic dataset.

Statistical Framework for Measuring Privacy Risks

Turning now to FIG. 4B, a flowchart is shown, illustrating a method 450 of using a statistical framework to measures privacy risks in anonymized datasets, according to one or more embodiments. First, at block 452, the method 450 may obtain a first synthetic dataset comprising a first plurality of datum. Next, at block 454, the method 450 may perform one or more privacy attacks on the first synthetic data (e.g., a singling out attack; a linkability attack; and/or an inference attack). Next, at block 456, the method 450 may measure a success rate for each of the one or more privacy attacks (e.g., by comparing results of the respective privacy attack against at least two baselines). In some implementations, a first baseline of the at least two baselines comprises performing the respective privacy attack on a control dataset from a same distribution as the first synthetic dataset, and a second baseline of the at least two baselines comprises performing a randomly-determined privacy attack (e.g., the type of privacy attack may be randomly determined) on the first synthetic dataset.

Next, at block 458, the method 450 may quantify a risk level for each of the one or more privacy attacks based, at least in part, on the respective success rate for the privacy attack. Finally, at block 460, the method 450 may output the quantified risk level for at least one of the one or more privacy attacks.

Example Electronic Devices

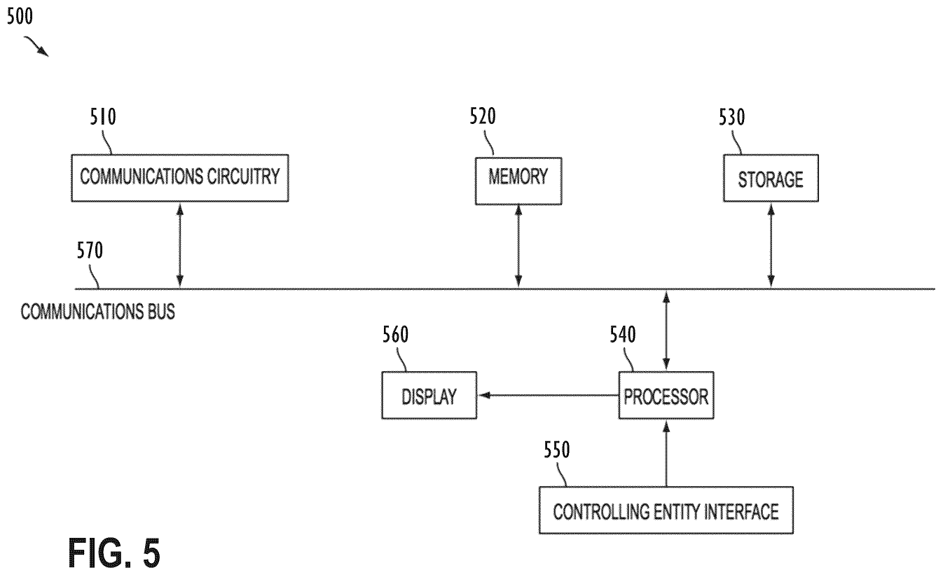

FIG. 5 is an example of a simplified functional block diagram illustrating a programmable device 500 according to one embodiment that can implement one or more of the processes, methods, steps, features or aspects described herein. The programmable device 500 may include one or more communications circuitry 510, memory 520, storage device 530, processor 540, controlling entity interface 550, display 560, and communications bus 570. Processor 540 may be any suitable programmable control device or other processing unit, and may control the operation of many functions performed by programmable device 500. Processor 540 may drive display 560 and may receive controlling entity inputs from the controlling entity interface 550. An embedded processor provides a versatile and robust programmable control device that may be utilized for carrying out the disclosed techniques.

Storage device 530 may store attribute combinations, software (e.g., for implementing various functions on device 500), preference information, device profile information, and any other suitable data. Storage device 530 may include one or more storage mediums for tangibly recording data and program instructions, including for example, a hard-drive or solid state memory, permanent memory such as ROM, semi-permanent memory such as RAM, or cache. Program instructions may comprise a software implementation encoded in any desired computer programming language.

Memory 520 may include one or more different types of storage modules that may be used for performing device functions. For example, memory 520 may include cache, ROM, and/or RAM. Communications bus 570 may provide a data transfer path for transferring data to, from, or between at least memory 520, storage device 530, and processor 540.

Although referred to as a bus, communications bus 570 is not limited to any specific data transfer technology. Controlling entity interface 550 may allow a controlling entity to interact with the programmable device 500. For example, the controlling entity interface 550 can take a variety of forms, such as a button, keypad, dial, click wheel, mouse, touch or voice command screen, or any other form of input or user interface.

In one embodiment, the programmable device 500 may be a programmable device capable of processing data. For example, the programmable device 500 may be a device such as any identifiable device (excluding smart phones, tablets, notebook and desktop computers) that have the ability to communicate and are embedded with sensors, identifying devices or machine-readable identifiers (a “smart device”), smart phone, tablet, notebook or desktop computer, or other suitable personal device.

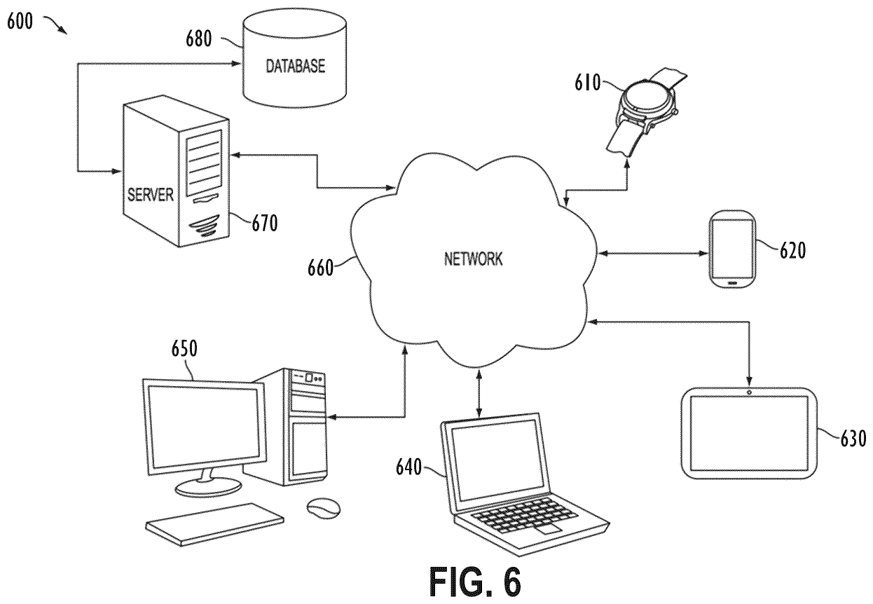

FIG. 6 is an example of a block diagram illustrating a system 600 of networked devices for implementing one or more of the processes, methods, steps, features or aspects described herein. A client application may be implemented on any of the smart device (i.e., wearable, movable or immovable smart devices) 610, smart phone 620, tablet 630, notebook 640, or desktop computer 650, for example. Each of these devices is connected by one or more networks 660 to the privacy server 670, to which is coupled a database 680 for storing synthetic datasets or other relevant information. The database 680 may be any desired form of data storage, including structured databases and non-structured flat files. The privacy server 670 may also provide remote storage for synthetic datasets or other relevant information that has been or will be delivered to the clients on devices 610, 620, 630, 640, 650, or other suitable devices either in the database 680 or in a different database (not shown).

Although a single network 660 is illustrated in FIG. 6, the network 660 may be multiple interconnected networks, and the privacy server 670 may be connected to each of the clients on 610, 620, 630, 640, 650, or other suitable devices via different networks 660. The network 660 may be any type of network, including local area networks, wide area networks, or the global internet.

### CONCLUSIONS

The Anonymeter framework is a robust way to measure various degrees of privacy leaks. Perhaps more importantly, Anonymeter never fails to report a risk value greater than zero when privacy leaks are present. Anonymeter also offers better scalability to large datasets than prior art approaches that require training dozens of models and generating thousands of synthetic datasets, which restricts the practical usability of the method to datasets with a maximum of tens of thousands of data records. Anonymeter only requires one realization of the synthetic dataset and can evaluate the privacy of large synthetic datasets with millions of rows within less than one day of compute time using rather inexpensive general purpose virtual machines with 64 virtual CPUs.

The evaluation of the Anonymeter framework on singling out, linkability, and inference risks highlights the effectiveness of the framework to provide a coherent assessment of legally-meaningful privacy metrics. Not only does Anonymeter allow for the analysis of general privacy leakage as a function of the attacker's power, but, at the same time, it helps identify concrete privacy violations in the synthetic datasets. In particular, Anonymeter significantly outperforms existing frameworks for privacy evaluation of synthetic data in both the detection of privacy leakage and computational complexity. This is a crucial step on the way towards leveraging the full potential of using synthetic data—while keeping track of the privacy implications.

Moreover, the modular nature of the Anonymeter framework facilitates the future integration of new and potentially stronger attacks for evaluating the three privacy risks analyzed herein. Privacy attacks that evaluate other aspects of privacy, such as membership inference, can also be integrated. This flexibility allows the Anonymeter framework to adapt to and to meet future requirements from emerging and changing privacy regulations.

Another advantage of the Anonymeter framework is that it separates the evaluation of the success rate of the privacy attacks from the calculation of the reported privacy risks. Due to the statistical nature of Anonymeter's risk quantification phase (where each attack simply yields a boolean array), the privacy risk is deduced from the main attack and the baselines, which provide the necessary context for turning attack success into expressive privacy risks.

Since the Anonymeter framework treats the synthetic data generation mechanism as a black box and solely utilizes the generated dataset, the framework can be used for other forms of anonymized datasets. Anonymeter can even be applied to an original dataset to identify individual data records with high privacy risks. This assessment can, among others, serve as a pre-filtering mechanism to identify—and, for example, remove—high-risk data records before training a generative model on the original data. This can lead to reduced privacy risks for the generated synthetic dataset.

The Anonymeter framework can also be directly applied to quantify the privacy risks associated to a particular individual (or subgroup of individuals) in a dataset. Therefore, the generation of guesses in the attack phase only has to specify the respective individual(s) instead of using random targets. To provide a more fine-grained risk assessment over the entire dataset, the target selection in the framework could also rely on identifying targets with high privacy risks and selecting these for generating the guesses. This would help approximate the upper bound on privacy leakage in the dataset more closely than an assessment over randomly-chosen targets.

Synthetic data has the potential to mitigate existing tensions between the need to share and utilize sensitive datasets and the privacy concerns of the individuals whose data is included in these datasets. The fact that the actual privacy leakage in such datasets is hard to quantify hinders leveraging the high potential of the data. To close this gap, the Anonymeter statistical framework, as described herein, may be used to jointly quantify different privacy risks in synthetic datasets. Within this framework, concrete attacks are used to measure the privacy risks of singling out, linkability, and inference, i.e., the three risks that anonymization methods must mitigate to be legally-compliant to existing privacy legislations.

Anonymeter is the first framework to propose practical attacks directly measuring the singling out and linkability risks posed by the release of a synthetic dataset. Anonymeter is able to report privacy risks in a coherent and fine-grained manner, making the framework a valuable resource for identifying privacy leakage and quantifying the corresponding risks. Anonymeter also significantly outperforms prior works, both in finding privacy leaks as well as in usability.

Combining Synthetic Data and Statutory Pseudonymization helps to resolve conflicts between data privacy and utility by improving each without requiring degradation of the other.

### Additional Comments

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention. For instance, as a non-limiting example, in alternative embodiments, portions of operations described herein may be re-arranged and performed in different order than as described herein.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. A system, comprising:
a memory having, stored therein, computer program code; and
one or more processing units operatively coupled to the memory and configured to execute instructions in the computer program code that cause the one or more processing units to:
obtain a first cleartext dataset comprising a first plurality of datum;
generate a first synthetic dataset based, at least in part, on the first cleartext dataset, wherein the first synthetic dataset comprises a second plurality of datum;
apply at least one pseudonymization technique to at least one datum in the first synthetic dataset to generate a first enhanced synthetic dataset; and
perform at least one analysis operation on the first enhanced synthetic dataset.

2. The system of claim 1, wherein the instructions in the computer program code further cause the one or more processing units to:
transmit the first enhanced synthetic dataset to a third-party.

3. The system of claim 1, wherein the instructions that cause the one or more processing units to apply at least one pseudonymization technique to at least one datum in the first synthetic dataset further comprise instructions that cause the one or more processing units to:
pseudonymize at least one field name in the first synthetic dataset.

4. The system of claim 1, wherein the instructions that cause the one or more processing units to apply at least one pseudonymization technique to at least one datum in the first synthetic dataset further comprise instructions that cause the one or more processing units to:
perform a generalization operation on at least one field in the first synthetic dataset.

5. The system of claim 1, wherein the instructions that cause the one or more processing units to apply at least one pseudonymization technique to at least one datum in the first synthetic dataset further comprise instructions that cause the one or more processing units to:
apply at least one pseudonymization technique to fewer than all of the second plurality of datum in the first synthetic dataset.

6. The system of claim 1, wherein the instructions in the computer program code further cause the one or more processing units to:
train a machine learning (ML) model with the first enhanced synthetic dataset.

7. The system of claim 6, wherein the instructions in the computer program code further cause the one or more processing units to:
use the trained ML model to restore the first enhanced synthetic dataset to a cleartext dataset.

8. A system, comprising:
a memory having, stored therein, computer program code; and
one or more processing units operatively coupled to the memory and configured to execute instructions in the computer program code that cause the one or more processing units to:
obtain a first synthetic dataset comprising a first plurality of datum;
perform one or more privacy attacks on the first synthetic data;
measure a success rate for each of the one or more privacy attacks;
quantify a risk level for each of the one or more privacy attacks based, at least in part, on the respective success rate for the privacy attack; and
output the quantified risk level for at least one of the one or more privacy attacks.

9. The system of claim 8, wherein the instructions in the computer program code comprise part of a modular privacy framework.

10. The system of claim 8, wherein the instructions that cause the one or more processing units to quantify a risk level for each of the one or more privacy attacks further comprise instructions that cause the one or more processing units to:
compare results of the respective privacy attack against at least two baselines.

11. The system of claim 10, wherein a first baseline of the at least two baselines comprises performing the respective privacy attack on a control dataset from a same distribution as the first synthetic dataset.

12. The system of claim 11, wherein a second baseline of the at least two baselines comprises performing a randomly-determined privacy attack on the first synthetic dataset.

13. The system of claim 8, wherein the one or more privacy attacks comprise one or more of:
a singling out attack; a linkability attack; or an inference attack.

14. A computer-implemented method, comprising:
obtaining, a first framework, a first cleartext dataset comprising a first plurality of datum;
generating, by the framework, a first synthetic dataset based, at least in part, on the first cleartext dataset, wherein the first synthetic dataset comprises a second plurality of datum;
applying, by the framework, at least one pseudonymization technique to at least one datum in the first synthetic dataset to generate a first enhanced synthetic dataset; and
performing, by the framework, at least one analysis operation on the first enhanced synthetic dataset.

15. The computer-implemented method of claim 14, further comprising:
transmitting, by the framework, the first enhanced synthetic dataset to a third-party.

16. The computer-implemented method of claim 14, wherein applying, by the framework, at least one pseudonymization technique to at least one datum in the first synthetic dataset further comprises:
pseudonymizing at least one field name in the first synthetic dataset.

17. The computer-implemented method of claim 14, wherein applying, by the framework, at least one pseudonymization technique to at least one datum in the first synthetic dataset further comprises:
performing a generalization operation on at least one field in the first synthetic dataset.

18. The computer-implemented method of claim 14, wherein applying, by the framework, at least one pseudonymization technique to at least one datum in the first synthetic dataset further comprises:
applying at least one pseudonymization technique to fewer than all of the second plurality of datum in the first synthetic dataset.

19. The computer-implemented method of claim 14, further comprising:
training a machine learning (ML) model with the first enhanced synthetic dataset.

20. The computer-implemented method of claim 19, further comprising:
using the trained ML model to restore the first enhanced synthetic dataset to a cleartext dataset.
